(19) United States
(12) Patent Application Publication
(10) Pub. No.: US 2025/0260844 A1
(43) Pub. Date: Aug. 14, 2025

(54) Flexibility of Module Order in Video Coding Systems

(71) Applicant: TENCENT AMERICA LLC, Palo Alto, CA (US)

(72) Inventors: Ding DING, Washington, DC (US); Roman CHERNYAK, Palo Alto, CA (US); Shan LIU, Palo Alto, CA (US)

(73) Assignee: TENCENT AMERICA LLC, Palo Alto, CA (US)

(21) Appl. No.: 19/034,911

(22) Filed: Jan. 23, 2025

Related U.S. Application Data
(60) Provisional application No. 63/552,606, filed on Feb. 12, 2024.

(51) Int. Cl. H04N 19/88; H04N 19/70

(52) U.S. Cl. CPC H04N 19/88; H04N 19/70

(57) ABSTRACT

This disclosure relates generally to generally to embodiments of this disclosure are directed to video coding, and more particularly to adaptive ordering of encoding and decoding modules. The encoding/decoding order may be adaptively determined by content characteristics of the video and/or additional information/parameters associated with the various encoding/decoding modules.

This application is based on and claims the benefit of priority to U.S. Provisional Patent Application No. 63/552,606 filed on Feb. 12, 2024, and entitled “FLEXIBILITY OF MODULE ORDER IN VIDEO CODING SYSTEMS,” which is herein incorporated by reference in its entirety.

### TECHNICAL FIELD

This disclosure relates generally to embodiments of this disclosure are directed to video coding, and more particularly to adaptive ordering of encoding and decoding modules.

### BACKGROUND

Video or images may be consumed by human users for a variety of purposes, for example entertainment, education, etc. Thus, video coding or image coding may often utilize characteristics of human visual systems for better compression efficiency while maintaining good subjective quality.

With the rise of machine learning applications, along with the abundance of sensors, many intelligent platforms have utilized video for machine vision tasks such as object detection, segmentation or tracking. As a result, encoding video or images for consumption by machine tasks has become an interesting and challenging problem. This has led to the introduction of Video Coding for Machines (VCM) studies.

While the various embodiments are described in the context of VCM, the underlying principles are generally applicable other video coding systems.

### SUMMARY

This disclosure relates generally to generally to embodiments of this disclosure are directed to video coding, and more particularly to adaptive ordering of encoding and decoding modules. The encoding/decoding order may be adaptively determined by content characteristics of the video and/or additional information/parameters associated with the various encoding/decoding modules.

In some example implementations, a method for decoding a video is disclosed. The method may include receiving an encoded bitstream of the video; determining a sequential order for executing a plurality of decoding modules based on an indication extracted from the encoded bitstream; and decoding the encoded bitstream by executing the plurality of decoding modules according to sequential order. The plurality of decoding modules comprises at least one of a Region of Interest (ROI) module, a temporal upsampling module, a spatial upsampling module, a post filtering module, a bit depth restoration module, or a format adapter module.

In the example implementations above, the sequential order is selected based on the indication from a set of predefined sequential orders.

In any one of the example implementations above, the set of redefined sequential orders of the plurality of decoding modules, if executed, comprise at least one of: the RoI module, followed by the spatial upsampling module, followed by the temporal upsampling module, followed by the post filter module, followed by the bit depth restoration module, and followed by the format adapter module; the bit depth restoration module, followed by the RoI module, followed by the spatial upsampling module, followed by the temporal upsampling module, followed by the post filter module, and followed by the format adapter module; and the RoI module, followed by the temporal upsampling module, followed by the spatial upsampling module, followed by the post filter module, followed by the bit depth restoration module, and followed by the format adapter module.

In any one of the example implementations above, the sequential order is adaptively determined.

In any one of the example implementations above, the indication is derived from at least one content characteristics of the video as extracted from the encoded bitstream; and the at least one content characteristics comprises at last one of a temporal dependency, a content complexity, a color complexity, a motion complexity, a texture characteristic, a dynamic range variation, a foreground-background segmentation, a ratio of high frequency area, a ratio of RoI area.

In any one of the example implementations above, the indication is derived based on an inter-frame content movement and wherein a higher degree of the inter-frame content movement indicates earlier execution of the temporal upsampling module.

In any one of the example implementations above, the inter-frame content movement is determined by: a number of pixels that have inter-frame changes; a percentage of pixels having inter-frame value change; and/or an average inter-frame pixel value change.

In any one of the example implementations above, the indication is derived based on the content complexity and wherein a higher level of the content complexity indicates earlier execution of the spatial upsampling module.

In any one of the example implementations above, the indication is derived based on the ratio of high frequency area and wherein a higher level of the ratio of high frequency area indicates earlier execution of the spatial upsampling module.

In any one of the example implementations above, the indication is derived based on of RoI area and wherein a higher level of the ratio RoI area indicates earlier execution of the ROI module.

In any one of the example implementations above, the sequential order is selected from a plurality of sequential orders based on a set of threshold levels of the at least one content characteristics.

In any one of the example implementations above, the indication is derived by processing a set of video characteristics derived from the encoded bitstream using a pre-trained neural network.

In any one of the example implementations above, the indication is derived from a set of additional parameters extracted from the encoded bitstream associated with the at least one of plurality of decoding modules.

In any one of the example implementations above, the set of additional parameters comprises at least one or a temporal resample ratio or a spatial resample ratio.

In any one of the example implementations above, the method further include determining that the sequential order is adaptively determined based on a flag in the encoded bitstream; and determining the sequential order based on a signaled index of the sequential order among a plurality of predefined sequential orders.

In any one of the example implementations above, the sequential order is asymmetric from an encoding order of a plurality of encoding modules corresponding to the plurality of decoding modules for generating the encoded bitstream.

In some other example implementations, a method for encoding a video is disclosed. The method may include adaptively determining a sequential order for executing a plurality of encoding modules; encoding the video by executing the plurality of encoding modules according to sequential order to generate an encoded bitstream; and including an indication in the encoded bitstream to indicate the sequential order to a decoder. The plurality of encoding modules comprises at least one of a Region of Interest (ROI) module, a temporal upsampling module, a spatial upsampling module, a post filtering module, a bit depth restoration module, or a format adapter module.

In the example implementations above, the sequential order is determined based on at least one content characteristics of the video; and the at least one content characteristics comprises at last one of a temporal dependency, a content complexity, a color complexity, a motion complexity, a texture characteristic, a dynamic range variation, a foreground-background segmentation, a ratio of high frequency area, a ratio of RoI area.

In any one of the example implementations above, the indication comprises: a flag for indicating that the sequential order is adaptively determined; and an index of the sequential order among a plurality of predefined sequential orders.

In some other example implementations, a non-transient computer-readable storage medium for storing an encoded bitstream of a video is disclosed. The encoded bitstream may include a flag for indicating whether an adaptive sequential order for executing a plurality of decoding modules is to be applied by a decoder; and when the flag indicates that the adaptive sequential order is to be applied, an indication of the adaptive sequential among a plurality of predefined sequential orders for executing the plurality of decoding modules.

Aspects of the disclosure also provide an electronic device or apparatus function as encoder or decoder including a circuitry configured to carry out any of the method implementations above.

Aspects of the disclosure also provide non-transitory computer-readable medium for storing computer instructions which when executed by a computer for 3D mesh processing, cause the computer to perform any one of the method implementations above.

### BRIEF DESCRIPTION OF THE DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, according to embodiments.

FIG. 2 is a schematic illustration of an example computer system in accordance with an embodiment.

FIG. 3 is a block diagram of an example architecture for performing video coding, according to embodiments.

FIG. 4 illustrates various decoding modules that may be utilized in a VCM decoder.

FIG. 5 is a flowchart of an example process for utilizing a plurality of decoding modules.

FIG. 6 is a flowchart of an example process for encoding a video.

### DETAILED DESCRIPTION OF EMBODIMENTS

Throughout this specification and claims, terms may have nuanced meanings suggested or implied in context beyond an explicitly stated meaning. The phrase “in one embodiment” or “in some embodiments” as used herein does not necessarily refer to the same embodiment and the phrase “in another embodiment” or “in other embodiments” as used herein does not necessarily refer to a different embodiment. Likewise, the phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments/implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

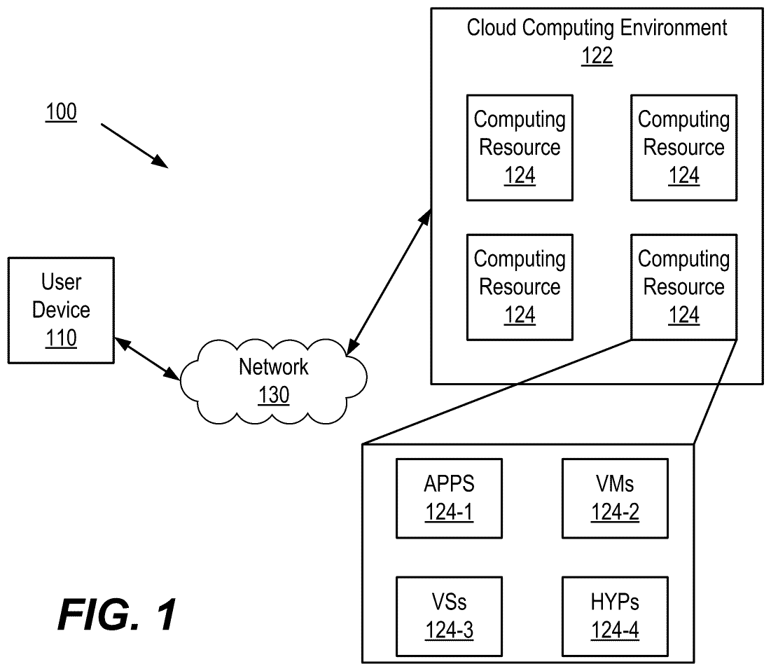

FIG. 1 is a diagram of an application environment 100 in which methods, apparatuses, and systems described herein may be implemented, according to the example embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown in FIG. 1, the platform 120 may be hosted in a cloud computing environment 122. Notably, while implementations described herein describe the platform 120 as being hosted in the cloud computing environment 122, in some implementations, the platform 120 may not be cloud-based (i.e., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (“APPs”) 124-1, one or more virtual machines (“VMs”) 124-2, virtualized storage (“VSs”) 124-3, one or more hypervisors (“HYPs”) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (“OS”). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

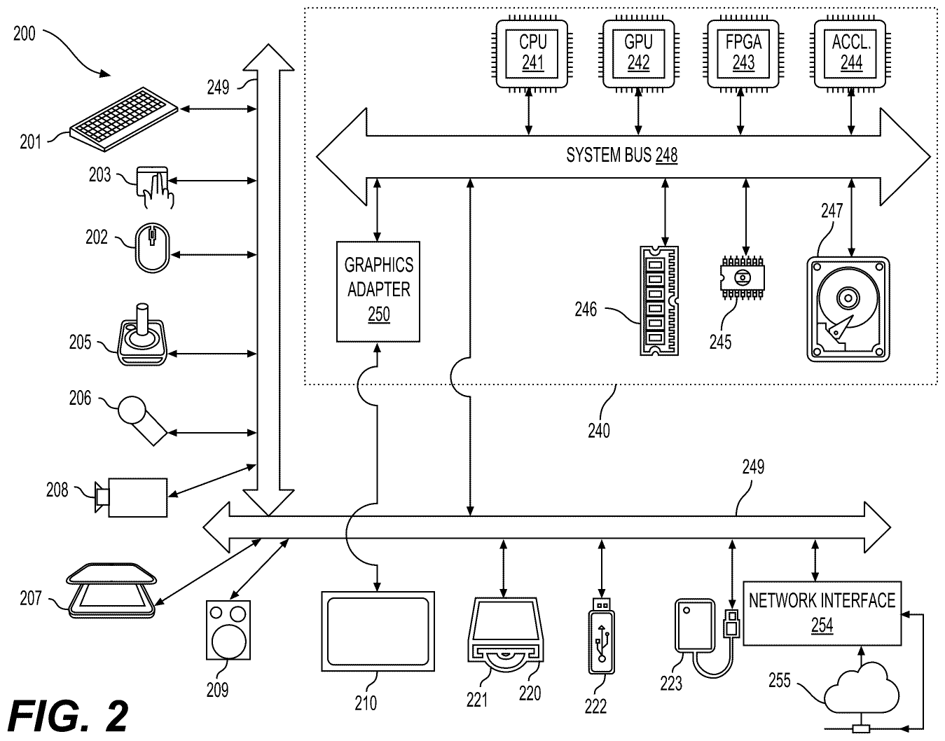

The techniques and implementations described below can be implemented as computer software using computer-readable instructions and physically stored in one or more computer-readable media. For example, FIG. 2 shows a computer system (200) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 2 for computer system (200) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (200).

Computer system (200) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (201), mouse (202), trackpad (203), touch screen (210), data-glove (not shown), joystick (205), microphone (206), scanner (207), camera (208).

Computer system (200) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (210), data-glove (not shown), or joystick (205), but there can also be tactile feedback devices that do not serve as input devices), audio output devices (such as: speakers (209), headphones (not depicted)), visual output devices (such as screens (210) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (200) can also include human accessible storage devices and their associated media such as optical media including CD/DVD ROM/RW (220) with CD/DVD or the like media (221), thumb-drive (222), removable hard drive or solid state drive (223), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (200) can also include an interface (254) to one or more communication networks (255). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general-purpose data ports or peripheral buses (249) (such as, for example USB ports of the computer system (200)); others are commonly integrated into the core of the computer system (200) by attachment to a system bus as described below (for example Ethernet interface into a PC computer system or cellular network interface into a smartphone computer system). Using any of these networks, computer system (200) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (240) of the computer system (200).

The core (240) can include one or more Central Processing Units (CPU) (241), Graphics Processing Units (GPU) (242), specialized programmable processing units in the form of Field Programmable Gate Areas (FPGA) (243), hardware accelerators for certain tasks (244), graphics adapters (250), and so forth. These devices, along with Read-only memory (ROM) (245), Random-access memory (246), internal mass storage such as internal non-user accessible hard drives, SSDs, and the like (247), may be connected through a system bus (248). In some computer systems, the system bus (248) can be accessible in the form of one or more physical plugs to enable extensions by additional CPUs, GPU, and the like. The peripheral devices can be attached either directly to the core's system bus (248), or through a peripheral bus (249). In an example, the screen (210) can be connected to the graphics adapter (250). Architectures for a peripheral bus include PCI, USB, and the like.

CPUs (241), GPUs (242), FPGAs (243), and accelerators (244) can execute certain instructions that, in combination, can make up the aforementioned computer code. That computer code can be stored in ROM (245) or RAM (246). Transitional data can be also be stored in RAM (246), whereas permanent data can be stored for example, in the internal mass storage (247). Fast storage and retrieve to any of the memory devices can be enabled through the use of cache memory, that can be closely associated with one or more CPU (241), GPU (242), mass storage (247), ROM (245), RAM (246), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (200), and specifically the core (240) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (240) that are of non-transitory nature, such as core-internal mass storage (247) or ROM (245). The software implementing various embodiments of the present disclosure can be stored in such devices and executed by core (240). A computer-readable medium can include one or more memory devices or chips, according to particular needs. The software can cause the core (240) and specifically the processors therein (including CPU, GPU, FPGA, and the like) to execute particular processes or particular parts of particular processes described herein, including defining data structures stored in RAM (246) and modifying such data structures according to the processes defined by the software. In addition, or as an alternative, the computer system can provide functionality as a result of logic hardwired or otherwise embodied in a circuit (for example: accelerator (244)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

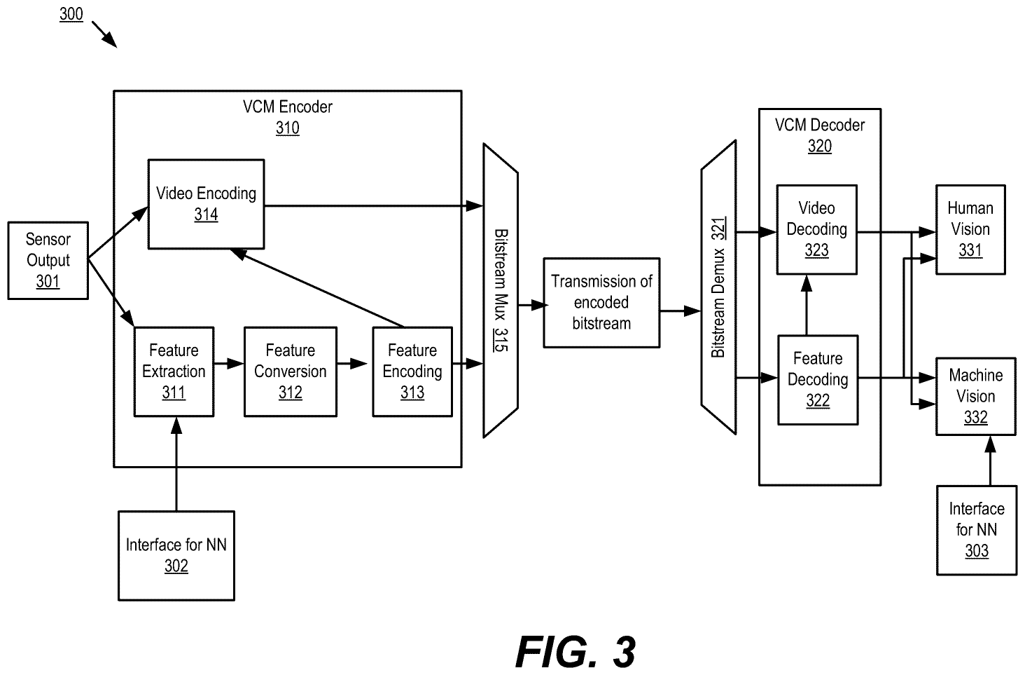

FIG. 3 is a block diagram of an example architecture 300 for performing video coding, according to embodiments. In embodiments, the architecture 300 may be a video coding for machines (VCM) architecture, or an architecture that is otherwise compatible with or configured to perform VCM coding. For example, architecture 300 may be compatible with “Use cases and requirements for Video Coding for Machines” (ISO/IEC JTC 1/SC 29/WG 2 N18), “Draft of Evaluation Framework for Video Coding for Machines” (ISO/IEC JTC 1/SC 29/WG 2 N19), and “Call for Evidence for Video Coding for Machines” (ISO/IEC JTC 1/SC 29/WG 2 N20), the disclosures of which are incorporated by reference herein in their entireties.

In embodiments, one or more of the elements illustrated in FIG. 3 may correspond to, or be implemented by, one or more of the elements discussed above with respect to FIGS. 1-2, for example one ore more of the user device 110, the platform 120, the device 200, or any of the elements included therein.

As can be seen in FIG. 3, the architecture 300 may include a VCM encoder 310 and a VCM decoder 320. In some example embodiments, the VCM encoder may receive sensor input 301, which may include for example one or more input images, or an input video. The sensor input 301 may be provided to a feature extraction module 311 which may extract features from the sensor input, and the extracted features may be converted using feature conversion module 312, and encoded using feature encoding module 313. In embodiments, the term “encoding” may include, may correspond to, or may be used interchangeably with, the term “compressing”. The architecture 300 may include an interface 302, which may allow the feature extraction module 311 to interface with a neural network (NN) which may assist in performing the feature extraction.

The sensor input 301 may be provided to a video encoding module 314, which may generate an encoded video. In some example embodiments, after the features are extracted, converted, and encoded, the encoded features may be provided to the video encoding module 314, which may use the encoded features to assist in generating the encoded video. In embodiments, the video encoding module 314 may output the encoded video as an encoded video bitstream, and the feature encoding module 313 may output the encoded features as an encoded feature bitstream. In embodiments, the VCM encoder 310 may provide both the encoded video bitstream and the encoded feature bitstream to a bitstream multiplexer 315, which may generate an encoded bitstream by combining the encoded video bitstream and the encoded feature bitstream.

In embodiments, the encoded bitstream may be received by a bitstream demultiplexer (demux), which may separate the encoded bitstream into the encoded video bitstream and the encoded feature bitstream, which may be provided to the VCM decoder 320. The encoded feature bitstream may be provided to the feature decoding module 322, which may generate decoded features, and the encoded video bitstream may be provided to the video decoding module, which may generate a decoded video. In embodiments, the decoded features may also be provided to the video decoding module 323, which may use the decoded features to assist in generating the decoded video.

In embodiments, the output of the video decoding module 323 and the feature decoding module 322 may be used mainly for machine consumption, for example machine vision module 332. In embodiments, the output can also be used for human consumption, illustrated in FIG. 3 as human vision module 331. A VCM system, for example the architecture 300, from the client end, for example from the side of the VCM decoder 320, may perform video decoding to obtain the video in the sample domain first. Then one or more machine tasks to understand the video content may be performed, for example by machine vision module 332. In embodiments, the architecture 300 may include an interface 303, which may allow the machine vision module 332 to interface with an NN which may assist in performing the one or more machine tasks.

As can be seen in FIG. 3, in addition to a video encoding and decoding path, which includes the video encoding module 314 and the video decoding module 323, another path included in the architecture 300 may be a feature extraction, feature encoding, and feature decoding path, which includes the feature extraction module 311, the feature conversion module 312, the feature encoding module 313, and the feature decoding module 322.

Embodiments may relate to methods for enhancing decoded video for machine vision, human vision, or human/machine hybrid vision. In embodiments, each decoded image, which may be generated for example by the VCM decoder 320, may be enhanced for machine vision or human vision using an enhancement module and metadata sent from the encoder side. In embodiments, these methods can be applied to any VCM codec. Although some embodiments may be described using broader terms such as “image/video,” or using more specific terms such as “image” and “video”, it may be understood that embodiments may be applied.

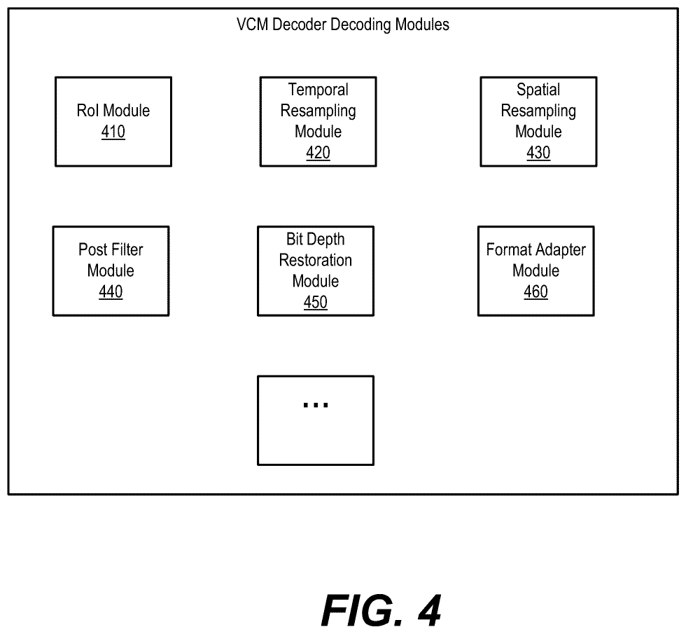

In some example implementations, during and after reconstruction of the input video, various encoding/decoding tools may be utilized to refine or repurpose the video. These tools may be referred to as encoding/decoding modules. From a decoding standpoint, for example, various decoding modules may be executed by a decoder after reconstruction of the image/video to refine or repurpose the image/video. For example, reconstructed image/video may be processed by various decoding module for machine vision in VCM. These tools may be selectively invoked and executed by the decoder. Correspondingly, these tools may be used in the encoder in its encoding process and decoding loop. These modules, in the context of VCM decoder, is shown in FIG. 4. Example decoding modules are shown as Region of Interest (RoI) module 410, temporal resampling module 420 (e.g., temporal upsampling module, temporal interpolation module, temporal extrapolation module, etc.), spatial resampling module 430 (e.g., spatial upsampling module), post filter module 440, bit depth restoration module 450, format adapter module 460, and the like. These modules may be invoked in certain order during or post reconstruction of the encoded video.

In some example implementations, the execution of these modules, either on the encoder side or on the decoder side, may follow a predefined execution order. For example, the order of execution of these modules, if applied, may be predefined as the RoI module, followed by the spatial resampling module (e.g., spatial upsampling module), followed by the temporal resampling module (e.g., temporal upsampling module), followed by the post filter module, followed by the bit depth restoration module, and followed by the format adapter module. For another example, the order of execution of these modules, if applied, may be predefined as the bit depth restoration module, followed by the RoI module, followed by the spatial resampling module, followed by the temporal resampling module, followed by the post filter module, and followed by the format adapter module. For yet another example, the order of execution of these modules, if applied, may be predefined as the RoI module, followed by the temporal resampling module, followed by the spatial resampling module, followed by the post filter module, followed by the bit depth restoration module, and followed by the format adapter module. Any other predefined execution of these modules may be predefined. Because the execution order of these modules is predefined, both the encoder and the decoder are aware of such execution order and no signaling may be needed in the bitstream. Following one of these orders, the output of a preceding module is input in the next module in a sequential manner.

The predefined execution order above may be defined for the encoder. As such, the encoder may execute the encoding version of these modules in the predefined order whereas the decoder may execute the decoding version of these modules in reverse of the predefined order, as an example.

The predefined execution order above may be defined for the decoder. As such, the encoder may choose to execute the encoding version of these modules in a reverse of the predefined order whereas the decoder may execute the decoding version of these modules in the predefined order.

In some implementations, the predefined execution order of these modules may be mandatory or recommended only for decoders and the encoder may maintain flexibility in determining an order of execution when performing encoding.

The further example implementations below enable flexible execution order of these modules in either or both of the encoder side and the decoder side. Such flexible encoding/decoding module order execution can be implemented in any encoding/decoding level, e.g., in the frame level, the sequence level, the picture level, and any other suitable levels. The flexible execution order may also be referred to as adaptive execution order. Such flexibility or adaptability may provide enhanced coding gain and less coding loss, and improved performance for machine vision in VCM.

In some example implementations, a set of execution orders may be predefined and one of them may be adaptively selected at various coding level (e.g., frame level, slice level, picture level, etc.). The set of predefined orders of execution may be known to both the encoders and the decoders and may be identified by their indexes among the set of execution orders.

The set of predefined execution orders, for example may include a first predefined order in which the RoI module is executed, followed by the spatial resampling module, followed by the temporal resampling module, followed by the post filter module, followed by the bit depth restoration module, and followed by the format adapter module. The set of predefined execution orders may further include a second predefined order in which the bit depth restoration module is executed, followed by the RoI module, followed by the spatial resampling module, followed by the temporal resampling module, followed by the post filter module, and followed by the format adapter module. The set of predefined execution orders may further include a second predefined order in the RoI module, followed by the temporal resampling module, followed by the spatial resampling module, followed by the post filter module, followed by the bit depth restoration module, and followed by the format adapter module. The set of predefined execution orders may further include other execution orders. The plurality of modules many include other modules not explicitly described above. These predefined execution orders may be specified from the encoding standpoint or from the decoding standpoint.

For flexibility, one execution order may be adaptively selected from the set of predefined execution orders at a time. Alternatively, the execution order may be adaptively modified from frame to frame, slice to slice to slice, etc. The selection or modification of the execution order may adaptively vary from frame to frame, or from sequence to sequence, or from slice to slice, or from picture to picture, etc.

In some example implementations, the adaptability of the execution order may be based on one of one or more content characteristics associated with the video being encoded/decoded. The one or more content characteristics include but are not limited to temporal dependency, content complexity, color complexity, motion complexity, texture characteristic, dynamic range variation, foreground-background segmentation, ratio of high frequency area, ratio of RoI area.

A particular execution order of the various modules described above may be determined by one of these content characteristics above. Alternatively, modification of the current execution order may be based on of these content characteristics above. For example, the execution order may be determined or modified based on motion complexity from frame to frame. In particular, consider a video where actions move quickly from one frame to the next. In such a scenario, the adaptive change in, e.g., the decoder's execution order would involve increasing the priority of temporal resampling modules (e.g., temporal interpolation modules) or selecting an execution order that prioritizes the temporal resampling module. In other words, in the selected or modified execution order, the temporal resampling modules are executed earlier.

For example, the decoder may analyze two consecutive frames by comparing corresponding pixels or groups of pixels. If a significant number of pixels have changed values beyond a certain number threshold, the decoder may determine that a fast movement is detected and that an execution order having an earlier execution of the temporal resampling modules may be used.

For another example, the movement may be quantified by the decoder by calculating an average change in pixel values from frame to frame. Such average change in pixel values may be used for the decoder to detect fast movement. For example, the decoder may determine that a fast movement is detected when the average change in pixel values in the frame is higher than a predefined pixel value change threshold. Alternatively, the decoder may determine that a fast movement is detected when a percentage of the average change value from frame to frame with respect the average pixel value is higher than a predefine percentage threshold. A higher percentage or greater average change usually suggests more significant motion, implying a faster pace for the motion. When the decoder detects such fast movement, an execution order that prioritize temporal resampling module (or have earlier execution for the temporal resampling module) may be used.

A particular execution order of the various modules described above may alternatively be adaptively determined or modified based on the content complexity. As an example, consider a complex urban scene with details, including moving vehicles, pedestrians, and changing signage. In such scenarios, the decoder may be configured to assess the spatial complexity by analyzing the variance in pixel values across a frame or across frames, detecting the dense activity and intricate details that characterize the scene. For example, the content complexity may be quantified by pixel value variations across a frame. Given this high content complexity, the adaptive change of execution order may involve prioritizing spatial resampling modules within the decoder's processing chain. For example, spatial resampling module may be more prioritized when the pixel value variation across a frame is equal to or higher than a predefined threshold in comparison to when the pixel value variation across the frame is lower than the predefined threshold.

A particular execution order of the various modules described above may alternatively be adaptively determined or modified based on ratio of high frequency areas. For example, the decoder may perform an analysis to identify areas within the frame that exhibit high spatial frequencies, indicative of fine details and sharp edges. The ratio of high-frequency areas may be quantified based on the proportion of the frame's area that contains these details compared to the overall frame size. If this ratio exceeds a predetermined proportion threshold, the decoder may adaptively prioritize a module intended for perform sharpening and detail enhancement, specifically for these high-frequency areas.

A particular execution order of the various modules described above may alternatively be adaptively determined based on RoI areas. For example, the decoder may conduct an analysis to determine the RoI Area for a frame. If this ratio is higher than a predetermined threshold, the decoder may then adaptively select or modify its execution order by prioritizing the RoI module among the other modules.

In some of the example implementations provided above, a threshold for a particular content characteristic may be established or predefined, where the execution order is adaptively selected or modified depending on whether the value of the particular content characteristics exceeds or falls below this threshold. However, in some other example implementations, multiple thresholds for a particular content characteristics may be established or predefined, thereby allowing for a more fine-tuned adjustment of the execution order and enhanced flexibility.

For example, in the context of the content characteristics being the temporal dependency, three distinct thresholds: threshold1, threshold2, and threshold3 may be established or predefined, where threshold1<threshold2<threshold3. This arrangement enables four different adaptive choices of the execution order or four different adaptive manners of execution order modification based on the value representing temporal dependency relative to these multiple thresholds.

In some example implementations above, the modification of a current execution order according to a particular context characteristics may involve advancing a corresponding module relative to other modules with the order of the other modules unchanged. The amount of advancement (number of positions of advancement in the execution order) of the corresponding module may be determined by the quantification of the particular content characteristics.

While the examples above determines or modifies execution order of the various modules based on a particular content characteristics, the underlying principles also applies usage of a combination of content characteristics. Merely as an example, the decoder module execution order may be adaptively determined or modified based on both temporal dependency and content complexity.

In some example implementations, a neural network model may be used to adaptively predict the module execution order. The neural network may be pre-trained. The neural network, for example may take a set of derived video characteristic as input and generate predicted execution order of the various modules above, from frame to frame, or sequence to sequence, or picture to picture.

In some example implementations, the module execution order may depend on information related to one of more of the various modules. For example, the execution sequence position of a module may adaptively depend on other modules' additional information. Such additional information comprise information of temporal resample, spatial resample, and bit depth truncation, and the like.

For example, the temporal resample module may be associated with a temporal resample ratio (e.g., upsampling ratio). In an example, if the temporal resample ratio is 2, then the execution order may be set as: temporal resampling module (e.g., temporal upsampling module), spatial resampling module, RoI module, post filter module, bit depth restoration module, format adapter module. Otherwise, if the temporal resample ratio is 4, then the execution order may be set as: bit depth restoration module, spatial resampling module, RoI module, temporal resampling module, post filter module, format adapter module.

For another example, the spatial resampling module may be associated with a spatial resample ratio. The module execution order may depend on such spatial resample ratio. For example, if the spatial resample ratio is 0.5, then a first pre-defined module execution order may be used. If the spatial resample ratio is 0.75, then a second pre-defined module execution order may be used. If the spatial resample ratio is of other values, then a third pre-defined module execution order may be used.

The module information above may be signaled in the bitstream of the video for the decoder to extract without actually decoding or reconstructing the video frames.

In some example implementations, the flexible or adaptive execution order of decoder modules may be facilitated by signaling mechanisms originating from the encoder side. Specifically, the encoder may perform the various analysis described above or other analysis on the input video content and adaptively determine the execution order of the decoding modules (e.g., from frame to frame, slice to slice, sequence to sequence, picture to picture, etc.) and signal the decoder of the order or reordering in the bitstream. This approach ensures that the decoder's dynamic module ordering or reordering is directly informed by the encoder's analysis of the video content, allowing for a highly optimized decoding process tailored to the specific characteristics of each video sequence or frame or slice or picture. The signaling of the execution order may be accomplished through high-level syntax embedded within the video stream, such as Supplemental Enhancement Information (SEI) messages, Video Supplemental Enhancement Information (VSEI), or other metadata carriers designed for this purpose. These messages may contain instructions for the decoder regarding the preferred or optimal order of module execution for the upcoming frames or sequences.

An example of signaling syntax structure is shown below.

| | Descriptor |
|---|---|
| adaptive_module_execution_order_data ( ) { | |
| adaptive_module_execution_order_flag | u(1) |
| if(adaptive_module_execution_order_flag) { | |
| module_execution_order_idx | u(n) |
| } | |
| byte_alignment( ) | |
| } | |

The various syntax elements above described below:

adaptive_module_execution_order_flag indicates whether adaptive execution order of decoding modules is to be applied. This syntax element being equal to 1 specifies that adaptive module execution order is enabled. This syntax elements being equal to 0 specifies that adaptive module execution order is disabled.

module_execution_order_idx is an n-bit unsigned integer with values that can range from 0 to n−1. Each index value indicates an execution order. For example, if the descriptor of module_execution_order_idx is u(2), it may be equal to 0, 1, 2, or 3, specifying one of four different execution orders which may be predefined or signaled separately. Merely as an example:

Idx 0 may indicate the following order: RoI module, spatial resample module, temporal resample module, post filter module, bit depth restoration module, format adapter module.

Idx 1 may indicate the following order: spatial resample module, RoI module, temporal resample module, post filter module, bit depth restoration module, format adapter module.

Idx 2 may indicate the following order: temporal resample module, spatial resample module, RoI module, post filter module, bit depth restoration module, format adapter module.

Idx 3 may indicate the following order: bit depth restoration module, spatial resample module, RoI module, temporal resample module, post filter module, format adapter module.

The example implementations above focus on decoder analysis of either or both of the signaling information and content characteristics/module information to adaptively determine execution order of the various decoding modules. However, the encoder when using encoding modules corresponding the various decoding modules, may follow similar analysis in order to determine the order of execution of the encoding modules. In some implementations, the orders of execution of the encoding and decoding modules from the encoder and decoder side, respectively, may be symmetric, or mirror on another, meaning that modules executed early on the encoder side are processed last on the decoder side. That is the order of execution of the decoding modules may be reverse of that of execution of the corresponding encoding modules. For example, the encoder may determine the order of encoding modules and signal the symmetric order of decoding modules in the bitstream. For another example, both the encoder and the decoder may follow the same order determination analysis based on the content characteristics and/or additional module information to derive the execution order of the encoding or decoding modules. The order for execution of the encoding modules and the order for execution of the decoding modules may be derived as being symmetric.

In some other example implementations, the symmetrical restriction above may be lifted, allowing the execution order on the decoder side to be asymmetrical, or independent of the encoder's order. In such implementations, different order adaptation methods may be applied separately at the encoder and decoder sides. Even if the execution order is signaled in the bitstream by the encoder, the decoder may not need to follow such signaled order may still decide to independently perform analysis and adaptive execution order determination.

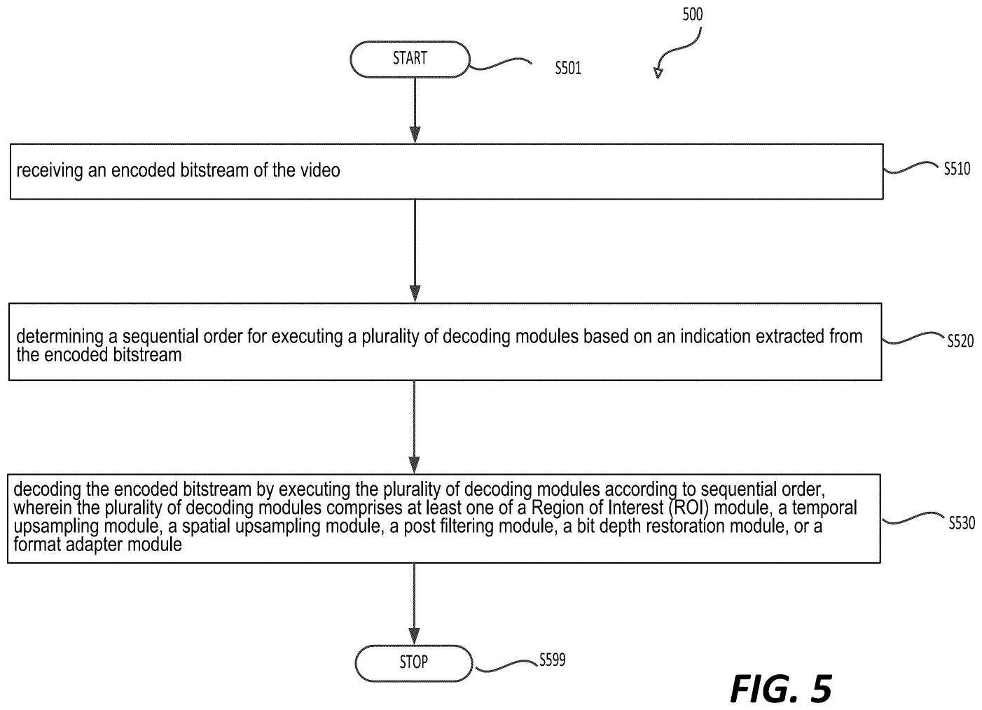

FIG. 5 shows a flow chart for an example process (500) according to an embodiment of the disclosure. The process (500) starts at step (S501). In Step (S510), an encoded bitstream of the video is received. In Step (S520), a sequential order for executing a plurality of decoding modules is determined based on an indication extracted from the encoded bitstream. In Step (S530), the encoded bitstream is decoded by executing the plurality of decoding modules according to sequential order. The plurality of decoding modules above comprises at least one of a Region of Interest (ROI) module, a temporal upsampling module, a spatial upsampling module, a post filtering module, a bit depth restoration module, or a format adapter module The procedure (500) stops at (S599).

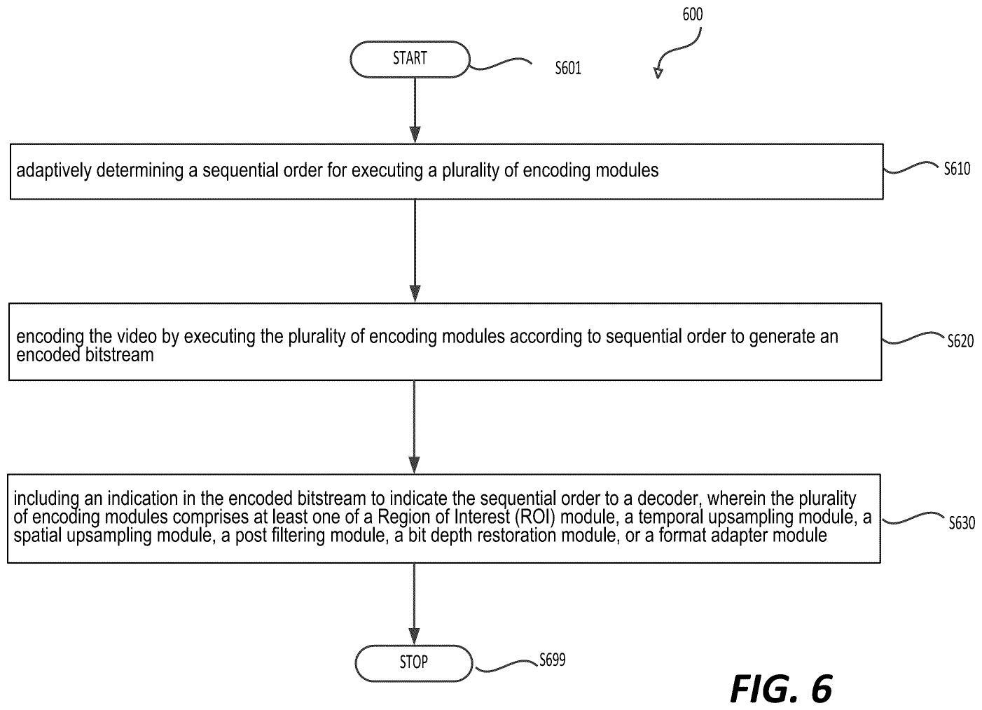

FIG. 6 shows a flow chart for an example process (600) according to an embodiment of the disclosure. The process (1600) starts at step (S601). In Step (S610), a sequential order for executing a plurality of encoding modules is adaptively determined. In Step (S620), the video is encoded by executing the plurality of encoding modules according to sequential order to generate an encoded bitstream. The plurality of encoding modules above comprises at least one of a Region of Interest (ROI) module, a temporal upsampling module, a spatial upsampling module, a post filtering module, a bit depth restoration module, or a format adapter moduleIn Step (S630), an indication in the encoded bitstream is included to indicate the sequential order to a decoder. The procedure (600) stops at (S699).

The processes (500), and (600) can be suitably adapted. Step(s) in the processes (500) and (600) can be modified and/or omitted. Additional step(s) can be added. Any suitable order of implementation can be used.

The techniques disclosed in the present disclosure may be used separately or combined in any order. Further, each of the techniques (e.g., methods, embodiments), encoder, and decoder may be implemented by processing circuitry (e.g., one or more processors or one or more integrated circuits). In some examples, the one or more processors execute a program that is stored in a non-transitory computer-readable medium.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method for decoding a video, comprising:
receiving an encoded bitstream of the video;
determining a sequential order for executing a plurality of decoding modules based on an indication extracted from the encoded bitstream; and
decoding the encoded bitstream by executing the plurality of decoding modules according to sequential order,
wherein the plurality of decoding modules comprises at least one of a Region of Interest (ROI) module, a temporal upsampling module, a spatial upsampling module, a post filtering module, a bit depth restoration module, or a format adapter module.

2. The method of claim 1, wherein the sequential order is selected based on the indication from a set of predefined sequential orders.

3. The method of claim 2, wherein the set of redefined sequential orders of the plurality of decoding modules, if executed, comprise at least one of:
the RoI module, followed by the spatial upsampling module, followed by the temporal upsampling module, followed by the post filter module, followed by the bit depth restoration module, and followed by the format adapter module;
the bit depth restoration module, followed by the RoI module, followed by the spatial upsampling module, followed by the temporal upsampling module, followed by the post filter module, and followed by the format adapter module; and
the RoI module, followed by the temporal upsampling module, followed by the spatial upsampling module, followed by the post filter module, followed by the bit depth restoration module, and followed by the format adapter module.

4. The method of claim 1, wherein the sequential order is adaptively determined.

5. The method of claim 4, wherein:
the indication is derived from at least one content characteristics of the video as extracted from the encoded bitstream; and
the at least one content characteristics comprises at last one of a temporal dependency, a content complexity, a color complexity, a motion complexity, a texture characteristic, a dynamic range variation, a foreground-background segmentation, a ratio of high frequency area, a ratio of RoI area.

6. The method of claim 5, wherein the indication is derived based on an inter-frame content movement and wherein a higher degree of the inter-frame content movement indicates earlier execution of the temporal upsampling module.

7. The method of claim 6, wherein the inter-frame content movement is determined by:
a number of pixels that have inter-frame changes;
a percentage of pixels having inter-frame value change; and/or
an average inter-frame pixel value change.

8. The method of claim 5, wherein the indication is derived based on the content complexity and wherein a higher level of the content complexity indicates earlier execution of the spatial upsampling module.

9. The method of claim 5, wherein the indication is derived based on the ratio of high frequency area and wherein a higher level of the ratio of high frequency area indicates earlier execution of the spatial upsampling module.

10. The method of claim 5, wherein the indication is derived based on of RoI area and wherein a higher level of the ratio RoI area indicates earlier execution of the ROI module.

11. The method of claim 5, wherein the sequential order is selected from a plurality of sequential orders based on a set of threshold levels of the at least one content characteristics.

12. The method of claim 4, wherein the indication is derived by processing a set of video characteristics derived from the encoded bitstream using a pre-trained neural network.

13. The method of claim 4, wherein the indication is derived from a set of additional parameters extracted from the encoded bitstream associated with the at least one of plurality of decoding modules.

14. The method of claim 13, wherein the set of additional parameters comprises at least one or a temporal resample ratio or a spatial resample ratio.

15. The method of claim 4, further comprising:
determining that the sequential order is adaptively determined based on a flag in the encoded bitstream; and
determining the sequential order based on a signaled index of the sequential order among a plurality of predefined sequential orders.

16. The method of claim 1, wherein the sequential order is asymmetric from an encoding order of a plurality of encoding modules corresponding to the plurality of decoding modules for generating the encoded bitstream.

17. A method for encoding a video, comprising:
adaptively determining a sequential order for executing a plurality of encoding modules;
encoding the video by executing the plurality of encoding modules according to sequential order to generate an encoded bitstream; and
including an indication in the encoded bitstream to indicate the sequential order to a decoder,
wherein the plurality of encoding modules comprises at least one of a Region of Interest (ROI) module, a temporal upsampling module, a spatial upsampling module, a post filtering module, a bit depth restoration module, or a format adapter module.

18. The method of claim 17, wherein:
the sequential order is determined based on at least one content characteristics of the video; and
the at least one content characteristics comprises at last one of a temporal dependency, a content complexity, a color complexity, a motion complexity, a texture characteristic, a dynamic range variation, a foreground-background segmentation, a ratio of high frequency area, a ratio of RoI area.

19. The method of claim 17, wherein the indication comprises:
a flag for indicating that the sequential order is adaptively determined; and
an index of the sequential order among a plurality of predefined sequential orders.

20. A non-transient computer-readable storage medium for storing an encoded bitstream of a video, the encoded bitstream comprising:
a flag for indicating whether an adaptive sequential order for executing a plurality of decoding modules is to be applied by a decoder; and
when the flag indicates that the adaptive sequential order is to be applied, an indication of the adaptive sequential among a plurality of predefined sequential orders for executing the plurality of decoding modules.
